(19) United States
(12) Patent Application Publication
(10) Pub. No.: US 2024/0002661 A1
(43) Pub. Date: Jan. 4, 2024

(54) TRANSPARENT COMPOSITIONS WITH GOOD ALCOHOL RESISTANCE AND FATIGUE STRENGTH

(71) Applicant: ARKEMA FRANCE, Colombes (FR)

(72) Inventors: Stefania CASSIANO GASPAR, SERQUIGNY (FR); Benoît BRULE, SERQUIGNY (FR); Mathieu SABARD, SERQUIGNY (FR); Regis CIPRIANI, SERQUIGNY (FR)

(73) Assignee: ARKEMA FRANCE, Colombes (FR)

(21) Appl. No.: 18/253,035

(22) PCT Filed: Nov. 15, 2021
(86) PCT No.: PCT/FR2021/052005

§ 371 Date: May 15, 2023

(30) Foreign Application Priority Data
Nov. 16, 2020 (FR) FR2011692

(51) Int. Cl. C08L 77/06; C08G 69/26

(52) U.S. Cl. CPC C08L 77/06; C08G 69/26; C08L 2201/10; C08L 2205/025

(57) ABSTRACT

A transparent molding composition, including by weight: (a) from 30 to 90% of at least one (co)polyamide of formula PACMY/Z, (b) from 10 to 70% by weight of at least one semi-crystalline copolyamide of formula A/WS, (c) from 0 to 10% of at least one impact modifier chosen from the polyether block amides (PEBA) and the core-shell polymers, (d) from 0 to 2% by weight of at least one additive, (e) from 0 to 5% by weight of a prepolymer; the sum of the proportions of each constituent of said composition being equal to 100%, the composition having good alcohol resistance as determined by an ethanol resistance test.

### TECHNICAL FIELD

The present invention relates to a transparent composition comprising a mixture of at least one (co)polyamide of formula PACMY/Z and at least one copolyamide of formula A/WS having good alcohol resistance, in particular to ethanol or isopropanol, low haze and improved fatigue strength.

### BACKGROUND ART

In various applications especially in the consumer electronics market (e.g. smart watches, smartphones, headphones, etc.), transparent materials with very good alcohol resistance, especially to ethanol or isopropanol, are required. Compositions that were previously suitable for these applications are now insufficient in view of the new requirements. Good processability and good overmolding capability (especially on reinforced products) are also necessary in this type of product.

Transparent polyamides (PA) synthesized from bis(4-aminocyclohexyl)methane (PACM) also referred to as P in the description, are known for their better ethanol resistance and better fatigue strength, in particular with respect to bis(4-amino-3-methylcyclohexyl)methane-based polyamides (also referred to as MACM or BMACM or B in the description). These products, in particular P12, are difficult to inject and overmold, especially on rigid materials (e.g. glass fiber reinforced polyamides) as these products are viscous and can crystallize when hot, which limits the implementation window.

Thus, patent U.S. Pat. No. 5,360,891 describes compositions comprising PACM and an aliphatic dicarboxylic acid such as dodecanedioic acid to yield a polyamide P12 which has good ethanol resistance but has the disadvantage of insufficient processability and fatigue strength.

The MACM-based transparent polyamide (B12) is known from EP0725101 but has lower ethanol resistance than P12.

Application US20110105697 describes compositions of MACMX/10Y/L type, especially comprising B12/1012 improving alcohol resistance with respect to B12 but having less ethanol resistance than P12.

Document US20030235666 then proposes the combination of P12 and B12 which then has good resistance to ethanol and fatigue but has insufficient processability.

It is therefore necessary to have compositions that have good alcohol resistance, low haze and good fatigue strength while maintaining good processability and good overmolding capability.

The present invention thus relates to a transparent molding composition, comprising by weight:
(a) from 30 to 90%, in particular from 35 to 85%, of at least one (co)polyamide of formula PACMY/Z, wherein:
PACM is bis(4-aminocyclohexyl)methane consisting of at least 30 mol % of trans,trans-bis(4-aminocyclohexyl)methane with respect to the sum of all the isomers of the PACM, preferentially from 35 to 60 mol %, especially from 40 to 55 mol %, in particular from 45 to 50.5 mol %,
Y is at least one aliphatic dicarboxylic acid,
Z is a repeating unit chosen from a unit obtained from at least one amino acid or a unit obtained from at least one lactam, or a unit XY1 obtained from the polycondensation of at least one aliphatic diamine X and at least one aliphatic dicarboxylic acid Y1,
Z being comprised from 0 to 15% by weight in the PACMY/Z (co)polyamide, with respect to the sum of the constituents of the (co)polyamide,
(b) from 10 to 70%, in particular from 15 to 65% by weight of at least one semi-crystalline copolyamide of formula A/WS,
A being as defined for Z,
W being chosen from 3,3′-dimethyl-4,4′-diamino-dicyclohexylmethane (MACM) and PACM as defined hereinbefore, W preferably being 3,3′-dimethyl-4,4′-diamino-dicyclohexylmethane (MACM),
S being an aromatic dicarboxylic acid, said aromatic dicarboxylic acid being chosen especially from isophthalic acid and terephthalic acid and the mixtures thereof, in particular said aromatic dicarboxylic acid being isophthalic acid,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
the sum of the proportions of each constituent of said composition being equal to 100%,
said composition having good alcohol resistance as determined by an ethanol resistance test.

The alcohol (ethanol) resistance is determined by optical observation (transmittance and haze) on injected plates in a mirror-polished mold of 100×100×1 mm³ after stressing (plate attached to an elliptical mandrel imposing a deformation of up to 3%) in a predetermined environment (ESC), that is in the present case placed in ethanol for 24 hours, according to ISO 22088:2006. The measurement of transmittance and the measurement of haze on the injected plates, in a mirror-polished mold, of 1 mm thickness having a width and length of 100 mm*100 mm are determined according to ASTM D 1003, before and after testing with alcohol, from said composition of the invention.

The ethanol resistance is advantageously considered to be good when the transmittance determined according to ASTM D 1003, after testing with alcohol, is greater than or equal to 90%.

Advantageously, the ethanol resistance is considered to be good when the haze determined according to ASTM D 1003, after testing with alcohol, is less than 5%.

More advantageously, the ethanol resistance is advantageously considered to be good when the transmittance determined according to ASTM D 1003, after testing with alcohol, is greater than or equal to 90% and the haze determined according to ASTM D 1003, after testing with alcohol, is less than 5%.

The inventors thus unexpectedly found that a mixture of at least one (co)polyamide PACMY/Z with at least one particular semi-crystalline copolyamide made it possible to obtain a composition having not only good ethanol resistance, low haze, but also improved fatigue strength, processability and overmolding capability, especially with respect to P12.

The processability of the compositions of the invention is especially improved with respect to that of a composition of P12.

P12 has the disadvantage of crystallizing when hot, and the compositions of the invention can be injected at a lower temperature than that of P12 and especially over a wider range of injection temperatures. In addition, the injection rate and injection speed of the compositions of the invention are higher than those of the injection of P12.

Especially, at iso-temperature and iso-conditions the present invention leads to lower injection pressures than those used for PACMYs, in particular for P12.

The overmolding of the compositions of said invention, in particular on polyamide, is also improved with respect to the overmolding of P12 on the same polyamides.

In one embodiment, the composition is free of glass fibers.

Glass fiber is understood to be any glass fiber, in particular that described by Frederick T. Wallenberger, James C. Watson and Hong Li, PPG industries Inc. (ASM Handbook, Vol 21: composites (#06781G), 2001 ASM International).

### Regarding the (Co)Polyamide of Formula PACMY/Z:

The nomenclature used to define the polyamides is described in ISO standard 1874-1:2011 “Plastics—Polyamide (PA) Moulding And Extrusion Materials—Part 1: Designation” and is well known to a skilled person.

The PACM (P) is bis(4-aminocyclohexyl)methane and consists of four isomers: a trans,trans isomer, a cis,cis isomer, a cis,trans isomer and a cis,trans isomer.

The PACM used in the present composition therefore comprises at least 30 mol % of trans,trans-bis(4-aminocyclohexyl)methane, with respect to the sum of all the isomers of the PACM, preferentially from 35 to 60 mol %, especially from 40 to 55 mol %, in particular from 45 to 50.5 mol %.

Y is at least one aliphatic dicarboxylic acid comprising 4 to 36 carbon atoms, advantageously 6 to 18 carbon atoms.

More advantageously, Y is at least one aliphatic dicarboxylic acid comprising 8 to 18 carbon atoms, advantageously 9 to 16 carbon atoms.

More preferentially, Y is a C10 or C12 aliphatic dicarboxylic acid, in particular C12.

The carboxylic diacid Y can be chosen from the linear or branched aliphatic carboxylic diacids, in particular linear.

When the dicarboxylic acid Y is aliphatic and linear, it may be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanoic acid (18), octadecanedioic acid (18), eicosanedioic acid (20), docosanedioic acid (22) and the fatty acid dimers containing 36 carbons.

Z is a repeating unit chosen from a unit obtained from at least one amino acid or a unit obtained from at least one lactam, or a unit XY1 obtained from the polycondensation of at least one aliphatic diamine X and at least one aliphatic dicarboxylic acid Y1.

When Z is at least one amino acid, also referred to as aminocarboxylic acid, said amino acid comprises 6 to 18 carbon atoms, preferentially 8 to 12 carbon atoms, more preferentially 10 to 12 carbon atoms. It can thus be chosen from 6-aminohexanoic acid, 7-aminoheptanoic acid, 8-aminooctanoic acid, 9-aminononanoic acid, 10-aminodecanoic acid, 11-aminoundecanoic acid and 12-aminododecanoic acid, 13-aminotridecanoic acid, 14-aminotetradecanoic acid, 15-aminopentadecanoic acid, 16-aminohexadecanoic acid, 17-aminoheptadecanoic acid and 18-aminooctadecanoic acid.

Preferentially, Z is a repeating unit which is a single aminocarboxylic acid.

When Z is a unit obtained from at least one lactam, said lactam comprises 6 to 18 carbon atoms, preferentially 8 to 12 carbon atoms, more preferentially 10 to 12 carbon atoms.

Preferentially, Z is a repeating unit which is a single lactam.

Advantageously, Z is a repeating unit chosen from a unit obtained from a C₁₁ amino acid or a unit obtained from a C₁₂ lactam, preferentially a unit obtained from a C₁₁ amino acid.

When Z is a unit XY1 obtained from polycondensation of at least one aliphatic diamine X and at least one aliphatic dicarboxylic acid Y1, said at least one aliphatic diamine X comprises 4 to 36 carbon atoms, advantageously 6 to 18 carbon atoms, advantageously 6 to 12 carbon atoms, advantageously 10 to 12 carbon atoms and said at least one aliphatic dicarboxylic acid Y1 comprises 4 to 36 carbon atoms, advantageously 6 to 18 carbon atoms, advantageously 6 to 12 carbon atoms, advantageously 8 to 12 carbon atoms.

The aliphatic diamine used to obtain this repeating unit XY1 is an aliphatic diamine that has a linear main chain comprising at least 4 carbon atoms.

This linear main chain can, if necessary, include one or several methyl and/or ethyl substituents; in the latter configuration, this is called a “branched aliphatic diamine”. In the case where the main chain does not include any substituent, the aliphatic diamine is called a “linear aliphatic diamine.”

Whether or not it includes methyl and/or ethyl substituents on the main chain, the aliphatic diamine used to obtain this repeating unit XY1 comprises 4 to 36 carbon atoms, advantageously 4 to 18 carbon atoms, advantageously 6 to 18 carbon atoms, advantageously 6 to 14 carbon atoms.

When this diamine is a linear aliphatic diamine, it then has the formula H2N—(CH2)x-NH2 and can be chosen for example from butanediamine (4), pentanediamine (5), hexanediamine (6), heptanediamine (7), octanediamine (8), nonanediamine (9), decanediamine (10), undecanediamine (11), dodecanediamine (12), tridecanediamine (13), tetradecanediamine (14), hexadecanediamine (16), octadecanediamine (18) and octadecenediamine (18). The linear aliphatic diamines that have just been mentioned can all be bio-sourced in the sense of standard ASTM D6866.

When this diamine is a branched aliphatic diamine, it can in particular be 2-methyl-pentanediamine, 2-methyl-1,8-octanediamine or trimethylene (2,2,4 or 2,4,4) hexanediamine.

The carboxylic diacid Y1 may be chosen from the linear or branched aliphatic carboxylic diacids.

When the dicarboxylic acid Y1 is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and the fatty acid dimers containing 36 carbons.

The fatty acid dimers mentioned above are dimerized fatty acids obtained by oligomerization or polymerization of monobasic unsaturated long-chain hydrocarbon fatty acids (such as linoleic acid and oleic acid), as described in particular in document EP 0,471,566.

Z may be present or non present. If it is present, Z is present up to 15% by weight in the (co)polyamide with respect to the sum of the constituents of the (co)polyamide.

Advantageously, PACMY/Z is chosen from PACM10, PACM12, PACM13, PACM14, PACM10/11, PACM12/11, PACM13/11, PACM14/11, PACM10/12, PACM12/12, PACM13/12 and PACM14/12.

More advantageously, Z is non present and PACMY is chosen from PACM10, PACM12, PACM13, PACM14.

If Z is present, advantageously, the average number of carbon atoms per nitrogen atom of Z is greater than or equal to 6, preferentially greater than or equal to 8.

### Regarding the Semi-Crystalline Copolyamide of Formula A/WS:

A semi-crystalline copolyamide, within the meaning of the invention, denotes a copolyamide that has a melting temperature (Tm) measured according to ISO standard 11357-3:2013 by DSC, and a crystallization enthalpy measured during the cooling step at a rate of 20 K/min by DSC according to ISO standard 11357-3 of 2013 greater than 25 J/g, preferably greater than 40 J/g.

Unit A in said copolyamide is as defined for Z hereinbefore with the difference that A is always present.

Unit W is chosen from 3,3′-dimethyl-4,4′-diamino-dicyclohexylmethane (MACM) and PACM as defined hereinbefore, preferably W is 3,3′-dimethyl-4,4′-diamino-dicyclohexylmethane (MACM).

When W is PACM, the copolyamide A/WS is then different from PACMY/Z.

S is an aromatic dicarboxylic acid.

The aromatic dicarboxylic acid S may be chosen from terephthalic acid (denoted T), isophthalic acid (denoted I) and 2,6-naphthalene dicarboxylic acid (denoted N) or mixtures thereof.

In particular S is an aromatic dicarboxylic acid and is chosen from terephthalic acid (denoted T), isophthalic acid (denoted I) or mixtures thereof, in particular said aromatic dicarboxylic acid is isophthalic acid.

In one embodiment, the weight content of A in the copolyamide A/WS is greater than or equal to 70% with respect to the sum of the constituents of the copolyamide.

Advantageously, the content by weight of A is from 70 to 95%, more particularly from 70 to 90%.

In one embodiment, A/WS is chosen from 11/BI, 12/BI, 11/BT, 12/BT, 11/BI/BT and 12/BI/BT, especially 11/BI, 12/BI, 11/BI/BT and 12/BI/BT, in particular 11/BI and 12/BI.

### Regarding the Impact Modifier:

The impact modifier may or may not be present, and when it is present its proportion is up to 10% by weight.

The impact modifier is chosen from the polyether block amides (PEBA) and the core-shell polymers.

Advantageously, polyolefins and SEBS are excluded from the compositions of the invention.

### Regarding the PEBAs:

Polyether block amides (PEBAs) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit obtained from the polycondensation:

of at least one diamine, said diamine preferentially being chosen from a linear or branched aliphatic diamine or a mixture thereof, and

of at least one carboxylic diacid, said diacid preferentially being chosen from: a linear or branched aliphatic diacid, or a mixture thereof, said diamine and said diacid comprising 4 to 36 carbon atoms, advantageously 6 to 18 carbon atoms,

said polyether units (Ba2) being especially derived from at least one polyalkylene ether polyol, especially a polyalkylene ether diol,
PEBAs especially result from the copolycondensation of polyamide sequences with reactive ends with polyether sequences with reactive ends, such as, inter alia:
1) Polyamide sequences with diamine chain ends with polyoxyalkylene sequences with dicarboxylic chain ends.
2) Polyamide sequences with dicarboxylic chain ends with polyoxyalkylene sequences with diamine chain ends obtained by cyanoethylation and hydrogenation of alpha-omega dihydroxylated aliphatic polyoxyalkylene sequences referred to as polyalkylene ether diols (polyetherdiols).
3) Polyamide sequences with dicarboxylic chain ends with polyetherdiols, the products obtained being, in this particular case, polyether ester amides. The copolymers of the invention are advantageously of this type.

The polyamide sequences with dicarboxylic chain ends come for example from the condensation of polyamide precursors in the presence of a chain-limiting carboxylic diacid.

The polyamide sequences with diamine chain ends come for example from the condensation of polyamide precursors in the presence of a chain-limiting diamine.

The polyamide and polyether block polymers may also comprise randomly distributed units. These polymers may be prepared by the simultaneous reaction of polyether and polyamide block precursors.

For example, polyetherdiol, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Alternatively, polyetherdiamine, polyamide precursors and a chain-limiting diacid can be reacted. The result is a polymer having essentially polyether blocks, polyamide blocks with highly variable length, but also the various reagents having randomly reacted which are distributed randomly (statistically) along the polymer chain.

Amide Unit (Ba1):

The amide unit (Ba1) corresponds to an aliphatic repeating unit as defined hereinbefore.

Advantageously, the amide unit (Ba1) is chosen from polyamide 11, polyamide 12, polyamide 610, polyamide 612, polyamide 1010, polyamide 1012, in particular polyamide 11.

More advantageously, the amide unit (Ba1) is chosen from polyamide 11 and polyamide 12.

Polyether Unit (Ba2):

The polyether units are especially derived from at least one polyalkylene ether polyol, in particular they are derived from at least one polyalkylene ether polyol, in other words, the polyether units consist of at least one polyalkylene ether polyol. In this embodiment, the expression “of at least one polyalkylene ether polyol” means that the polyether units consist exclusively of alcohol chain ends and therefore cannot be a polyetherdiamine triblock type compound.

The composition of the invention therefore is free of polyetherdiamine triblock.

Advantageously, the polyether units (Ba2) are chosen from polyethylene glycol (PEG), polypropylene glycol (PPG), polytrimethylene glycol (PO3G), polytetramethylene glycol (PTMG) and the mixtures or copolymers thereof, in particular PTMG.

The number average molecular weight (Mn) of the polyether blocks is advantageously between 200 and 4000 g/mol, preferably between 250 and 2500 g/mol, especially between 300 and 1100 g/mol.

The PEBA can be prepared by the following method in which:

in a first step, the polyamide blocks (Ba1) are prepared by polycondensation of the lactam(s), or

of the amino acid(s), or
of the diamine(s) and of the carboxylic diacid(s); and if necessary, of the comonomer(s) chosen from the lactams and the alpha-omega aminocarboxylic acids;
in the presence of a chain limiter chosen from the carboxylic diacids; then

in a second step, the polyamide blocks (Ba1) obtained are reacted with polyether blocks (Ba2) in the presence of a catalyst.

The general method for two-step preparation of the copolymers of the invention is known and is described, for example, in French patent FR 2 846 332 and in European patent EP 1 482 011.

The reaction for forming the block (Ba1) usually takes place between 180 and 300° C., preferably between 200 and 290° C., the pressure inside the reactor is between 5 and 30 bar, and is maintained for about 2 to 3 hours. The pressure is slowly reduced by bringing the reactor to atmospheric pressure, and then the excess water is distilled off, for example for an hour or two.

Once the polyamide with carboxylic acid ends has been prepared, the polyether and a catalyst are added. The polyether may be added in one or several stages, as can the catalyst. In an advantageous embodiment, the polyether is added first, the reaction of the OH ends of the polyether and the COOH ends of the polyamide begins with the formation of ester bonds and the removal of water. As much water as possible is removed from the reaction medium by distillation, and then the catalyst is introduced to complete the bonding of the polyamide blocks and the polyether blocks. This second step is carried out under stirring, preferably under a vacuum of at least 15 mm Hg (2000 Pa) at a temperature such that the reagents and copolymers obtained are in the molten state. By way of example, this temperature may be between 100 and 400° C. and most often between 200 and 300° C. The reaction is monitored by measuring the torque exerted by the molten polymer on the stirrer or by measuring the electrical power consumed by the stirrer. The end of the reaction is determined by the value of the target torque or power.

One or several molecules used as antioxidants, for example Irganox® 1010 or Irganox®245, may also be added during the synthesis, at the moment deemed most appropriate.

The PEBA preparation process may also be considered so that all the monomers are added at the beginning, in a single step, in order to perform the polycondensation:

of the lactam(s), or
of the amino acid(s), or
of the diamine(s) and the carboxylic diacid(s); and optionally of the other polyamide comonomer(s);

in the presence of a chain limiter chosen from the carboxylic diacids;

in the presence of the blocks (Ba2) (polyether);

in the presence of a catalyst for the reaction between the soft blocks (Ba2) and the blocks (Ba1).

Advantageously, said carboxylic diacid is used as a chain limiter, which is introduced in excess with respect to the stoichiometry of the diamine(s).

Advantageously, a derivative of a metal chosen from the group formed by titanium, zirconium and hafnium or a strong acid such as phosphoric acid, hypophosphorous acid or boric acid is used as catalyst.

The polycondensation can be carried out at a temperature of 240 to 280° C.

Generally speaking, the known copolymers with ether and amide units consist of linear and semi-crystalline aliphatic polyamide sequences (for example Arkema's “Pebax®”).

In one embodiment, the polyether block amide (PEBA) has a flexural modulus of less than 200 MPa, in particular less than 100 MPa, as measured according to ISO standard 178:2010 at 23° C.

In another embodiment, the PEBA has a density greater than or equal to 1, as determined according to ISO 1183-3:1999.

### Regarding the Core-Shell:

The impact modifier may also be a core-shell modifier, also referred to as “core-shell copolymer” or polymeric particle.

It has a weight average particle size of between 20 nm and 500 nm. Preferably, the weight average particle size of the polymer is between 20 nm and 400 nm, more preferably between 20 nm and 350 nm and advantageously between 20 nm and 300 nm.

The polymeric particle has a multilayer structure comprising at least one layer (A) comprising a polymer (A1) having a glass-transition temperature less than 0° C. and another layer (B) comprising a polymer (B1) having a glass-transition temperature greater than 60° C. Preferably, the polymer (B1) having a glass-transition temperature greater than 60° C. is the outer layer of the polymeric particle with a multilayer structure.

The polymeric particle according to the invention is obtained by a multi-step method, such as with two or three or several steps.

Such a method is described for example in documents US2009/0149600 or EP0,722,961.

Preferably, the polymer (A1) having a glass-transition temperature less than 0° C. in layer (A) is produced in the first step of the multi-step method forming the core of the polymer particle with a multilayer structure. Preferably, the polymer (A1) has a glass-transition temperature less than −5° C., more preferably less than −15° C., advantageously less than −25° C.

Preferably, the polymer (B1) having a glass-transition temperature greater than 60° C. is produced in the last step of the multi-step method forming the outer layer of the polymeric particle with a multilayer structure.

One or several additional intermediate layers obtained by one or several intermediate steps may be present.

The glass-transition temperature Tg of the polymer with several layers can be estimated for example by dynamic methods such as thermomechanical analysis.

The polymer (A1) and the layer (A) comprise from 0% by weight to less than 50% by weight of monomers containing aromatic groups. The polymer (B1) and the layer (B) comprise from 0% by weight to less than 50% by weight of monomers containing aromatic groups.

According to one embodiment, the polymer (B1) and the layer (B) do not comprise monomers that contain aromatic groups.

As regards the polymer (A1) having a glass-transition temperature less than 0° C., it comprises at least 50% by weight of polymeric units derived from isoprene or butadiene, and the layer (A) is the innermost layer of the polymeric particle having a multilayer structure. In other words, layer (A) comprising the polymer (A1) is the core of the polymeric particle.

By way of example, the polymer (A1) of the core may consist of isoprene homopolymers or butadiene homopolymers, isoprene-butadiene copolymers, isoprene copolymers with up to 98% by weight of a vinyl monomer and butadiene copolymers with up to 98% by weight of a vinyl monomer. The vinyl monomer may be styrene, an alkyl styrene, acrylonitrile, an alkyl (meth)acrylate or butadiene or isoprene or the mixtures thereof, provided that the polymer (A1) comprises less than 50% by weight of monomers containing aromatic groups.

The polymer (A1) may be cross-linked. Crosslinking monomers useful in the present invention comprise, but are not limited to, aromatic polyfunctional vinyl compounds such as divinylbenzene and divinyltoluene, polyhydric alcohols such as ethylene glycol dimethacrylate and 1,3-butanediol diacrylate, trimethacrylates, triacrylates, allyl carboxylates such as allyl acrylate and allyl methacrylate, and di- and tri-allyl compounds such as diallyl phthalate, diallyl sebacate and triallyltriazine.

The core-shell type impact modifiers may be functionalized or non-functionalized. In the case where the core-shell is functionalized, this allows better compatibility with the polyamide matrix of said invention. As an example, a functionalization of the maleic anhydride type is preferred.

### Regarding the Additive:

The additive is optional and ranges from 0 to 2%, in particular from 0.1 to 1% by weight.

It is obvious that said additive does not disrupt the transparency of said composition.

The additive is chosen from dyes, stabilizers, plasticizers, surfactants, nucleating agents, pigments, brighteners, antioxidants, lubricants, flame retardants, natural waxes, laser marking additives, and mixtures thereof.

As an example, the stabilizer may be a UV stabilizer, an organic stabilizer or more generally a combination of organic stabilizers, such as a phenol antioxidant (for example of the type Irganox 245 or 1098 or 1010 by Ciba-BASF), a phosphite antioxidant (for example Irgafos® 126 or Irgafos® 168 by Ciba-BASF) and even optionally other stabilizers like a HALS, which means hindered amine light stabilizer (for example Tinuvin 770 by Ciba-BASF), an anti-UV (for example Tinuvin 312 by Ciba), a phosphorus-based stabilizer. Amine antioxidants such as Crompton's Naugard 445 or polyfunctional stabilizers such as Clariant's Nylostab S-EED may also be used.

This stabilizer may also be a mineral stabilizer, such as a copper-based stabilizer. By way of example of such mineral stabilizers, mention may be made of halides and copper acetates. Secondarily, other metals such as silver may optionally be considered, but these are known to be less effective. These copper-based compounds containing are typically associated with alkali metal halides, particularly potassium.

By way of example, the plasticizers are chosen from benzene sulfonamide derivatives, such as n-butyl benzene sulfonamide (BBSA); ethyl toluene sulfonamide or N-cyclohexyl toluene sulfonamide; hydroxybenzoic acid esters, such as 2-ethylhexyl parahydroxybenzoate and 2-decylhexyl parahydroxybenzoate; esters or ethers of tetrahydrofurfuryl alcohol, like oligoethyleneoxytetrahydrofurfuryl alcohol; and esters of citric acid or of hydroxy-malonic acid, such as oligoethyleneoxy malonate.

Using a mixture of plasticizers would not be outside the scope of the invention.

### Regarding the Prepolymer:

The prepolymer may be present from 0 to 5% by weight in the composition.

The prepolymer may be chosen from linear or branched aliphatic, cycloaliphatic, semi-aromatic or even aromatic polyamide oligomers. The prepolymer may also be a copolyamide oligomer or a mixture of polyamide and copolyamide oligomers. Preferably, the prepolymer has a number average molecular weight Mn from 1000 to 10000 g/mol, in particular from 1000 to 5000 g/mol. In particular, it can be monofunctional NH2 if the chain limiter used is a monoamine for example. The number average molecular weight (Mn) or amine number is calculated according to the following formula: Mn=1000/[NH2], [NH2] being the concentration of amine functions in the prepolymer as determined, for example, by potentiometry.

Advantageously, the prepolymer is a linear aliphatic oligomer, in particular a mono NH2 aliphatic oligomer, especially a mono NH2 PA11.

### Regarding the Composition:

In a first embodiment, the transparent molding composition comprises, by weight:
(a) from 30 to 90%, in particular from 35 to 85%, especially 45 to 65% of at least one (co)polyamide of formula PACMY/Z,
(b) from 10 to 70%, in particular from 15 to 65%, especially 35 to 55% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
   the sum of the proportions of each constituent of said composition being equal to 100%.

In a first variant of this first embodiment, the composition comprises by weight:
(a) from 35 to 85% of at least one (co)polyamide of formula PACMY/Z,
(b) from 15 to 65% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
   the sum of the proportions of each constituent of said composition being equal to 100%.

In a second variant of this first embodiment, the composition comprises by weight:
(a) from 30 to 87%, in particular from 35 to 82%, especially from 45 to 62% of at least one (co)polyamide of formula PACMY/Z,
(b) from 10 to 70%, in particular from 15 to 62%, especially from 35 to 52% by weight of at least one semi-crystalline copolyamide of formula A/WS,
(c) from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
   the sum of the proportions of each constituent of said composition being equal to 100%.

In a third variant of this first embodiment, the composition comprises by weight:
(a) from 30 to 89.9%, in particular from 35 to 84.9%, especially from 45 to 64.9% of at least one (co)polyamide of formula PACMY/Z,
(b) from 10 to 70%, in particular from 15 to 64.9%, especially from 35 to 54.9% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0.1 to 1% by weight of at least one additive,
(e) from 0 to 5% by weight of a prepolymer;
   the sum of the proportions of each constituent of said composition being equal to 100%.

In a fourth variant of this first embodiment, the composition comprises by weight:
(a) from 30 to 89.9%, in particular from 35 to 84.9%, especially from 45 to 64.9% of at least one (co)polyamide of formula PACMY/Z,
(b) from 10 to 70%, in particular from 15 to 64.9%, especially from 35 to 54.9% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0.1 to 5% by weight of a prepolymer;
   the sum of the proportions of each constituent of said composition being equal to 100%.

In a fifth variant of this first embodiment, the composition comprises by weight:
(a) from 30 to 86.9%, in particular from 35 to 81.9%, especially from 45 to 61.9% of at least one (co)polyamide of formula PACMY/Z,
(b) from 10 to 70%, in particular from 15 to 61.9%, especially from 35 to 51.9% by weight of at least one semi-crystalline copolyamide of formula A/WS,
(c) from 3 to 6% of at least one impact modifier chosen from the polyether block amides (PEBA) and the core-shell polymers,
(d) from 0.1 to 1% by weight of at least one additive,
(e) from 0 to 5% by weight of a prepolymer;
   the sum of the proportions of each constituent of said composition being equal to 100%.

In a sixth variant of this first embodiment, the composition comprises by weight:
(a) from 30 to 86.9%, in particular from 35 to 81.9%, especially from 45 to 64.9% of at least one (co)polyamide of formula PACMY/Z,
(b) from 10 to 70%, in particular from 15 to 61.9%, especially from 35 to 51.9% by weight of at least one semi-crystalline copolyamide of formula A/WS,
(c) from 3 to 6% of at least one impact modifier chosen from the polyether block amides (PEBA) and the core-shell polymers,
(d) from 0 to 2% by weight, preferably 0.1 to 1% by weight of at least one additive,
(e) from 0.1 to 5% by weight of a prepolymer;
   the sum of the proportions of each constituent of said composition being equal to 100%.

In a seventh variant of this first embodiment, the composition comprises by weight:
(a) from 30 to 86.8%, in particular from 35 to 81.8%, especially from 35 to 51.9% of at least one (co)polyamide of formula PACMY/Z,
(b) from 10 to 70%, in particular from 15 to 61.8%, especially from 35 to 51.8% by weight of at least one semi-crystalline copolyamide of formula A/WS,
(c) from 3 to 6% of at least one impact modifier chosen from the polyether block amides (PEBA) and the core-shell polymers,
(d) from 0.1 to 1% by weight of at least one additive,
(e) from 0.1 to 5% by weight of a prepolymer;
   the sum of the proportions of each constituent of said composition being equal to 100%.

In an eighth variant of this first embodiment, the composition comprises by weight:
(a) from 45 to 65% of at least one (co)polyamide of formula PACMY/Z,
(b) from 35 to 55% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
   the sum of the proportions of each constituent of said composition being equal to 100%.

Advantageously, in the eight variants of this first embodiment, said composition is free of glass fibers.

In a second embodiment, the transparent molding composition consists of, by weight:
(a) from 30 to 90%, in particular from 35 to 85%, especially from 45 to 65% of at least one (co)polyamide of formula PACMY/Z,
(b) from 10 to 70%, in particular from 15 to 65%, especially from 35 to 55% by weight of at least one semi-crystalline copolyamide of formula A/WS,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
   the sum of the proportions of each constituent of said composition being equal to 100%.

In this second embodiment, there are also eight variants which are equivalent to those described hereinbefore for the first embodiment with the exception that said composition consists of the different constituents (a) to (e) in the proportions described.

Advantageously, in these two embodiments and the associated variants, the content by weight of A in the A/WS copolyamide is greater than or equal to 70%.

Advantageously, A/WS is chosen from 11/BI, 12/BI, 11/PI, 12/PI, 11/BT, 12/BT, 11/BI/BT, 11/PI/BT, 11/BI/PT, 11/PI/PT, 12/BI/BT, 12/PI/BT, 12/BI/PT and 12/PI/PT especially 11/BI, 12/BI, 11/PI, 12/PI, 11/BI/BT, 11/PI/BT, 11/BI/PT, 11/PI/PT, 12/BI/BT, 12/PI/BT, 12/BI/PT and 12/PI/PT.

Z may be present or non present. If present, the weight content of Z in the PACMY/Z copolyamide is up to 15%.

Advantageously PACMY/Z is chosen from PACM10, PACM12, PACM13, PACM14, PACM10/11, PACM12/11, PACM13/11, PACM14/11, PACM10/12, PACM12/12, PACM13/12 and PACM14/12.

More advantageously PACMY/Z is chosen from PACM12, PACM13, PACM14, PACM10/11, PACM12/11, PACM13/11, PACM14/11, PACM10/12, PACM12/12, PACM13/12 and PACM14/12.

More advantageously, Z is non present and PACMY is chosen from PACM10, PACM12, PACM13, PACM14.

Even more advantageously, Z is non present and PACMY is chosen from PACM12, PACM13, PACM14.

Advantageously, A/WS is chosen from 11/BI, 12/BI, 11/PI, 12/PI, 11/BT, 12/BT, 11/BI/BT, 11/PI/BT, 11/BI/PT, 11/PI/PT, 12/BI/BT, 12/PI/BT, 12/BI/PT and 12/PI/PT especially 11/BI, 12/BI, 11/PI, 12/PI, 11/BI/BT, 11/PI/BT, 11/BI/PT, 11/PI/PT, 12/BI/BT, 12/PI/BT, 12/BI/PT and 12/PI/PT, and PACMY/Z is chosen from PACM10, PACM12, PACM13, PACM14, PACM10/11, PACM12/11, PACM13/11, PACM14/11, PACM10/12, PACM12/12, PACM13/12 and PACM14/12.

More advantageously, A/WS is chosen from 11/BI, 12/BI, 11/PI, 12/PI, 11/BT, 12/BT, 11/BI/BT, 11/PI/BT, 11/BI/PT, 11/PI/PT, 12/BI/BT, 12/PI/BT, 12/BI/PT and 12/PI/PT especially 11/BI, 12/BI, 11/PI, 12/PI, 11/BI/BT, 11/PI/BT, 11/BI/PT, 11/PI/PT, 12/BI/BT, 12/PI/BT, 12/BI/PT and 12/PI/PT, and PACMY/Z is chosen from PACM12, PACM13, PACM14, PACM10/11, PACM12/11, PACM13/11, PACM14/11, PACM10/12, PACM12/12, PACM13/12 and PACM14/12.

Advantageously, Z=0.

In the latter case, A/WS is chosen from 11/BI, 12/BI, 11/PI, 12/PI, 11/BT, 12/BT, 11/BI/BT, 11/PI/BT, 11/BI/PT, 11/PI/PT, 12/BI/BT, 12/PI/BT, 12/BI/PT and 12/PI/PT especially 11/BI, 12/BI, 11/PI, 12/PI, 11/BI/BT, 11/PI/BT, 11/BI/PT, 11/PI/PT, 12/BI/BT, 12/PI/BT, 12/BI/PT and 12/PI/PT and PACMY is preferentially chosen from PACM10, PACM12, PACM13 and PACM14.

Advantageously, A/WS is chosen from 11/BI, 12/BI, 11/PI, 12/PI, 11/BT, 12/BT, 11/BI/BT, 11/PI/BT, 11/BI/PT, 11/PI/PT, 12/BI/BT, 12/PI/BT, 12/BI/PT and 12/PI/PT especially 11/BI, 12/BI, 11/PI, 12/PI, 11/BI/BT, 11/PI/BT, 11/BI/PT, 11/PI/PT, 12/BI/BT, 12/PI/BT, 12/BI/PT and 12/PI/PT and PACMY is preferentially chosen from PACM12, PACM13 and PACM14.

Advantageously, in these two embodiments and the associated variants, said composition is free of impact modifier.

Advantageously, said composition as defined hereinbefore in each of the embodiments and associated variants has a transmittance at 560 nm on a plate of 1 mm thickness greater than 91% determined according to ISO standard 13468-2:2006 before said ethanol resistance test.

Advantageously, said composition as defined hereinbefore in each of the embodiments has a transmittance at 560 nm on a plate of 1 mm thickness greater than 90% determined according to ISO standard 13468-2:2006 after said ethanol resistance test.

Advantageously, said composition as defined hereinbefore in each of the embodiments and associated variants has a transmittance at 560 nm on a plate of 1 mm thickness greater than 91% determined according to ISO standard 13468-2:2006 before said ethanol resistance test and a transmittance at 560 nm on a plate of 1 mm thickness greater than 90% determined according to ISO standard 13468-2:2006 after said ethanol resistance test.

Advantageously, said composition as defined hereinbefore in each of the embodiments and associated variants has a haze determined according to ASTM D 1003, after testing with alcohol of less than 5%.

Advantageously, said composition as defined hereinbefore in each of the embodiments and associated variants has a transmittance at 560 nm on a plate of 1 mm thickness greater than 91% determined according to ISO standard 13468-2:2006 before said ethanol resistance test and a transmittance at 560 nm on a plate of 1 mm thickness greater than 90% determined according to ISO standard 13468-2:2006 after said ethanol resistance test and said composition also has a haze determined according to ASTM D 1003, after testing with alcohol of less than 5%.

Said composition as defined hereinbefore has good fatigue strength as determined by a strength test in which the minimum number of cycles at 18 MPa is 350,000 cycles.

The strength test is performed on notched bars or on notched dumbbells, in particular on notched dumbbells. It is carried out at room temperature at a frequency of 5 Hz and under tension. The number of cycles is determined for a fixed stress, herein 18 MPa, before the sample breaks.

Advantageously, the composition defined hereinbefore has a Tg greater than or equal to 90° C., as determined by Dynamic Mechanical Analysis (DMA) according to ISO 6721-11:2019, in particular between 100 and 140° C.

Advantageously, the composition has an HDT (A) greater than or equal to 65° C., as determined according to ISO 75 f, in particular between 70 and 110° C., especially between 80 and 110° C.

The HDT (deflection temperature under load) was determined according to ISO standard 75 f (bars laid flat) method A (load 1.8 MPa), heating temperature increase rate 50° C.h⁻¹ of the polyamides of the invention on dry-conditioned samples.

Advantageously, said composition has good overmolding capability with a material such as polyamides and PEBAX®, in particular a rigid matrix, as determined by a wedge cleavage test.

Rigid matrix is understood to mean a polyamide optionally reinforced with fillers such as glass fibers, and more particularly a reinforced semi-crystalline aliphatic polyamide.

Good overmolding capability is characterized by little or no delamination after overmolding a composition of the invention with a rigid matrix as determined by a wedge cleavage test which is performed according to ISO 10354:1992 with:

Dynamometer: MTS370—Test speed: 5 mm/min
Temperature: 23° C. —Force cell: 100 KN
Thickness of the steel wedge: 3 mm

Adhesion will be evaluated as OK if there is no delamination after the wedge cleavage test. Adhesion will be evaluated as NOK in the case of very poor adhesion leading to no force being detected during the wedge cleavage test.

According to another aspect, the present invention relates to the use for the manufacture of an article, especially for electronics, sports, cosmetics, motor vehicles, household appliances, optics or industry.

Advantageously, the article is manufactured by injection molding.

According to another aspect, the present invention relates to the article obtained by injection molding with a composition as defined hereinbefore.

### EXAMPLES

Preparation of the Compositions of the Invention and Mechanical Properties:

The compositions of Table 1 were prepared by mixing granules of different constituents in molten state.

The PACM used in the examples and comparative examples of the invention consists of 45 to 50.5 mol % of trans,trans-bis(4-aminocyclohexyl)methane isomer with respect to the sum of all the isomers of the PACM.

PACM12: Produced by the applicant
PACM10: Produced by the applicant
PACM10/11 (97.5/2.5% by weight): Produced by the applicant
11/BI (93/7% by weight): Produced by the applicant
11/B10 (80/20% by weight): Produced by the applicant

### PA11: Rilsan® Arkema

These mixtures were processed by compounding on a co-rotating twin-screw extruder of diameter D=16 mm and length L=25×D.

These mixtures were compounded at a temperature of 270° C. The screw speed was set to 300 rpm and the flow rate to 3 kg/h.

All the ingredients were inserted into the main hopper.

For each mixture, granules were recovered and then injected.

### Alcohol (Ethanol) Resistance Test (Table 1):

The alcohol (ethanol) resistance is determined by optical observation (transmittance and haze) on injected plates in a mirror-polished mold of 100×100×1 mm³ after stressing (plate attached to an elliptical mandrel imposing a deformation of up to 3%) in a predetermined environment (ESC), that is in the present case placed in ethanol for 24 hours, according to ISO 22088:2006. The measurement of transmittance and the measurement of haze on the injected plates, in a mirror-polished mold, of 1 mm thickness having a width and a length of 100 mm*100 mm are determined according to ASTM D 1003, before and after testing with alcohol, from said composition of the invention.

The ethanol resistance is advantageously considered to be good when the transmittance determined according to ASTM D 1003, after testing with alcohol, is greater than or equal to 90%.

The ethanol resistance is advantageously considered to be good when the haze is less than 5%.

The ethanol resistance is advantageously considered to be good when the transmittance determined according to ASTM D 1003, after testing with alcohol, is greater than or equal to 90% and when the haze is less than 5%.

Measurement of transmittance and haze (Table 1): plates of 1 mm thickness were produced using the compositions of the invention and the comparative examples of Table 1.

The percentage of light transmitted or reflected at the wavelength of 560 nm was measured on the plates obtained hereinbefore, according to ISO standard 13468-2:2006. The measurements were taken before and after the alcohol resistance test (denoted Tr (%) @1 mm for transmittance and Haze (%) @1 mm for haze in the examples).

### Fatigue Test on Dry-Conditioned Bars (Table 2)

Operating Conditions:

### Bars: 80*10*4 mm³

Gap between jaws: 40 mm
Frequency: 5 Hz (no self-heating is observed at this frequency)
Test temperature: 23° C.
Servo-hydraulic dynamometer MTS810#1
Load cell: 25 KN
V-notch—thickness under notch 3.7 mm
Injection of 100*100*1 mm³ and 100*100*2 mm³ Plates with the Compositions I1 and C2 (Table 3) and 80*10*4 mm³ Bars (Table 4)

### Wedge Cleavage Test (Adhesion Table 1):

The wedge cleavage test is carried out according to ISO 10354:1992 with:

Dynamometer: MTS370—Test speed: 5 mm/min
Temperature: 23° C. —Force cell: 100 KN
Thickness of the steel wedge: 3 mm

The results of the different tests are presented in Tables 1 to 4 hereunder.

TABLE 1

| | I1 | I2 | I3 | I4 | C1 | C2 | C3 | C4 | C5 | C6 |
|---|---|---|---|---|---|---|---|---|---|---|
| PACM12 | 50 | 60 | 80 | 0 | 80 | 100 | 0 | 50 | 60 | 0 |
| 11/BI (93/7 wt. %) | 50 | 40 | 20 | 50 | 0 | 0 | 100 | 0 | 0 | 0 |
| 11/B10 (80/20 wt. %) | 0 | 0 | 0 | 0 | 0 | 0 | 0 | 50 | 40 | 0 |
| PACM10 | 0 | 0 | 0 | 0 | 0 | 0 | 0 | 0 | 0 | 100 |
| PACM10/11 | 0 | 0 | 0 | 50 | 0 | 0 | 0 | 0 | 0 | 0 |
| (97.5/2.5 wt. %) | | | | | | | | | | |
| PA11 | 0 | 0 | 0 | 0 | 20 | 0 | 0 | 0 | 0 | 0 |
| Tr (%) @1 mm before | 91.7 | 91.5 | 91.5 | 91.4 | 91.6 | 91.5 | 88.0 | 91.4 | 91.5 | 91.4 |
| ethanol testing | | | | | | | | | | |
| Haze (%) @1 mm | 0.6 | 1.3 | 1.1 | 1.6 | 0.8 | 0.4 | 7.7 | 1.6 | 1.4 | 0.5 |
| before ethanol | | | | | | | | | | |
| testing | | | | | | | | | | |
| Tr (%) @1 mm after | 90.9 | 90.7 | 91.4 | 90.5 | 89.0 | 89.3 | 87.0 | 79.8 | 78.4 | 89.0 |
| ethanol testing | | | | | | | | | | |
| Haze (%) @1 mm | 1.9 | 1.8 | 3.1 | 3.9 | 7.0 | 5.3 | 9.0 | 31.0 | 47.7 | 5.5 |
| after ethanol testing | | | | | | | | | | |
| Adhesion with rigid | OK | OK | OK | OK | OK | NOK | OK | OK | OK | NOK |
| matrix | | | | | | | | | | |

All percentages of the compositions are given by weight.
(I1-I4: compositions of the invention)
(C1-C6: comparative compositions)
OK means: Very good adhesion. No delamination.
NOK means: Poor adhesion. Impossible to detect a force value. Can be peeled by hand.

The compositions of the invention consistently exhibit the four criteria:
1) Transmittance before ethanol testing higher than 91%, and
2) Transmittance after ethanol testing higher than 90%, and
3) Overmolding capability (adhesion with rigid matrix)
4) Haze after ethanol testing less than 5%
   whereas the comparative compositions only exhibit two of these four criteria at most.

TABLE 2

| | I1 | C2 |
|---|---|---|
| PACM12 wt. % | 50 | 100 |
| 11/BI (93/7 wt. %) | 50 | 0 |
| Number of cycles at 18 | >680,000 | 320,000 |
| MPa (notched bar) | | |

The fatigue strength of the compositions of the invention is significantly greater than that of the comparative compositions.

TABLE 3

| | I1 | C2 | I1 | C2 |
|---|---|---|---|---|
| Plates | 100*100*1 mm³ | | 100*100*2 mm³ | |
| PACM12 | 50 | 100 | 50 | 100 |
| 11/BI (93/7 wt. %) | 50 | 0 | 50 | 0 |
| IV granulates | 1.19 | 1.15 | 1.19 | 1.15 |
| Feed Tinj/nozzle (° C.) | 260/290 | 260/290 | 260/290 | 260/290 |
| Tmold (° C.) | 40 | 40 | 40 | 40 |
| Flow rate (cm³/s) | 80 | 80 | 80 | 80 |
| Pinj. (bar) | 1124 | 1593 | 541 | 754 |

TABLE 4

| | |
|---|---|
| I1 | C2 |

| | |
|---|---|
| Bars | 80*10*4 mm³ |

| | | |
|---|---|---|
| PACM12 | 50 | 100 |
| 11/BI (93/7 wt. %) | 50 | 0 |
| IV granulates | 1.19 | 1.15 |
| Feed Tinj/nozzle (° C.) | 250/290 | 250/290 |
| Tmold (° C.) | 40 | 40 |
| Flow rate (cm³/s) | 30 | 30 |
| Pinj. (bar) | 511 | 778 |

The injectability of the compositions of the invention for obtaining plates or bars is much greater than that of the comparative compositions because of their much lower injection pressure.

The results presented hereinbefore show that the compositions of the invention exhibit better injectability (Tables 3 and 4), overmolding capability (Table 1) and fatigue strength (Table 2) than the comparative PACMY compositions.

Furthermore, the compositions of the invention exhibit greater ethanol resistance (Table 1) than the comparative compositions (a mixture of PACMY with an aliphatic polyamide, a mixture of PACMY with 11/B10 or a PACMY alone).

1. A transparent molding composition, comprising by weight:
(a) from 30 to 90% of at least one (co)polyamide of formula PACMY/Z, wherein:
PACM is bis(4-aminocyclohexyl)methane consisting of at least 30 mol % of trans,trans-bis(4-aminocyclohexyl)methane with respect to the sum of all the isomers of the PACM,
Y is at least one aliphatic dicarboxylic acid,
Z is a repeating unit chosen from a unit obtained from at least one amino acid or a unit obtained from at least one lactam, or a unit XY1 obtained from the polycondensation of at least one aliphatic diamine X and at least one aliphatic dicarboxylic acid Y1,
Z being comprised from 0 to 15% by weight in the PACMY/Z (co)polyamide, with respect to the sum of the constituents of the (co)polyamide,
(b) from 10 to 70% by weight of at least one semi-crystalline copolyamide of formula A/WS,
A being as defined for Z,
W being chosen from 3,3′-dimethyl-4,4′-diamino-dicyclohexylmethane (MACM) and PACM as defined hereinbefore,
S being an aromatic dicarboxylic acid,
said semi-crystalline copolyamide having a crystallization enthalpy measured during the cooling step at a rate of 20 K/min by DSC according to ISO standard 11357-3 of 2013 greater than 25 J/g,
(c) from 0 to 10%, preferentially from 3 to 6% of at least one impact modifier chosen from the polyether block amides (PEBA) and the core-shell polymers,
(d) from 0 to 2% by weight, preferably 0.1 to 1% by weight of at least one additive,
(e) from 0 to 5% by weight of a prepolymer;
the sum of the proportions of each constituent of said composition being equal to 100%,
said composition having good alcohol resistance as determined by an ethanol resistance test, determined by optical observation (transmittance and haze) on injected plates in a mirror-polished mold of 100×100×1 mm3 after stressing (plate attached to an elliptical mandrel imposing a deformation of up to 3%) in a predetermined environment (ESC), that is placed in ethanol for 24 hours, according to ISO 22088:2006, the measurement of transmittance and the measurement of haze on the injected plates, in a mirror-polished mold, of 1 mm thickness having a width and a length of 100 mm*100 mm being determined according to ASTM D 1003, before and after testing with alcohol, from said composition.

2. The transparent composition according to claim 1, wherein it has a transmittance at 560 nm on a plate of 1 mm thickness greater than 91% determined according to ISO standard 13468-2:2006 before said ethanol resistance test.

3. The transparent composition according to claim 2, wherein it has a transmittance at 560 nm on a plate of 1 mm thickness greater than 90% determined according to ISO standard 13468-2:2006 after said ethanol resistance test.

4. The transparent composition according to claim 1, wherein said composition has a haze determined according to ASTM D 1003, after testing with alcohol, of less than 5%.

5. The transparent composition according to claim 1, wherein said composition has good fatigue strength as determined by a strength test in which the minimum number of cycles at 18 MPa is 350,000 cycles,
said test being carried out on dry-conditioned bars according to the following operating conditions:
Bars: 80*10*4 mm3
Gap between jaws: 40 mm
Frequency: 5 Hz (no self-heating is observed at this frequency)
Test temperature: 23° C.
Servo-hydraulic dynamometer MTS810#1
Load cell: 25 KN
V-notch—thickness under notch 3.7 mm.

6. The composition according to claim 1, wherein the polyether block amide (PEBA) has a flexural modulus of less than 200 MPa, as measured according to ISO standard 178:2010 at 23° C.

7. The composition according to claim 1, wherein the PEBA has a density greater than or equal to 1, as determined according to ISO 1183-3:1999.

8. The composition according to claim 1, wherein Y is a C8 to C18 aliphatic dicarboxylic acid, preferably C9 to C16.

9. The composition according to claim 8, wherein Y is a C10 or C12 aliphatic dicarboxylic acid, preferably C12.

10. The composition according to claim 1, wherein the weight content of Z in the PACMY/Z copolyamide is 0.

11. The composition according to claim 1, wherein the weight content of Z in the PACMY/Z copolyamide is greater than 0 and Z is a repeating unit chosen from a unit obtained from at least one C6 to C18 amino acid, preferentially C8 to C12, more preferentially C10 to C12, or a unit obtained from at least one C6 to C18 lactam, preferentially C8 to C12, more preferentially C10 to C12, or a unit XY1 obtained from the polycondensation of at least one C4-C36 aliphatic diamine X, preferentially C6-C18, preferentially C6-C12, more preferentially C10-C12, with at least one C4-C36 aliphatic dicarboxylic acid Y1, preferentially C6-C18, preferentially C6-C12, more preferentially C8-C12, or a mixture thereof.

12. The composition according to claim 1, wherein Z is a repeating unit chosen from a unit obtained from at least one C6 to C18 amino acid, preferentially C8 to C12, more preferentially C10 to C12, or a unit obtained from at least one C6 to C18 lactam, preferentially C8 to C12, more preferentially C10 to C12.

13. The composition according to claim 1, wherein Z is a repeating unit chosen from a unit obtained from a C11 amino acid or a unit obtained from a C12 lactam, preferentially a unit obtained from a C11 amino acid.

14. The composition according to claim 1, wherein A is a repeating unit chosen from a unit obtained from at least one C6 to C18 amino acid, preferentially C8 to C12, more preferentially C10 to C12, or a unit obtained from at least one C6 to C18 lactam, preferentially C8 to C12, more preferentially C10 to C12.

15. The composition according to claim 1, wherein A is a repeating unit chosen from a unit obtained from a C11 amino acid or a unit obtained from a C12 lactam, preferentially a unit obtained from a C11 amino acid.

16. The composition according to claim 1, wherein said at least one additive is chosen from dyes, stabilizers, plasticizers, surfactants, nucleating agents, pigments, brighteners, antioxidants, lubricants, flame retardants, natural waxes and mixtures thereof.

17. The composition according to claim 1, wherein said composition has good overmolding capability with transparent polyamides, as determined by a wedge cleavage test, carried out according to ISO 10354:1992.

18. An article manufactured from the composition as defined in claim 1.

19. The article according to claim 18, wherein the article is manufactured by injection molding.

20. An object obtained by injection molding with a composition as defined in claim 1.
